(19) United States
(12) Patent Application Publication
(10) Pub. No.: US 2009/0243171 A1
(43) Pub. Date: Oct. 1, 2009

(54) Fluid filled type vibration damping device

(75) Inventors: Takanobu Nanno, Kasugai-shi (JP); Eiji Tanaka, Komaki-shi (JP)

Correspondence Address: OLIFF & BERRIDGE, PLC, P.O. BOX 320850, ALEXANDRIA, VA, 22320-4850, US

(73) Assignee: TOKAI RUBBER INDUSTRIES, LTD., KOMAKI-SHI (JP)

(21) Appl. No.: 12/382,924

(22) Filed: Mar. 26, 2009

(30) Foreign Application Priority Data
Mar. 28, 2008 (JP) 2008-086134
Apr. 28, 2008 (JP) 2008-116627

(51) Int. Cl. F16F 9/04

(52) U.S. Cl. 267/140.13

(57) ABSTRACT

A fluid filled vibration-damping device wherein a main orifice passage and a sub-orifice passage interconnecting a pressure-receiving chamber and an equilibrium chamber; an input-end moveable plate having restricted deformation, situated on a wall of an intermediate chamber and undergo displacement so as to transmit pressure from the pressure-receiving chamber to the intermediate chamber and give rise to pressure fluctuations in the intermediate chamber; an output-end moveable plate situated on a different wall from the input-end moveable plate in the intermediate chamber and adapted to transmit pressure fluctuations of the intermediate chamber to the equilibrium chamber to dispel pressure fluctuations of the intermediate chamber, and having restricted deformation such that an amount of capacity variability permitted in association with displacement is smaller than that of the input-end moveable plate.

### INCORPORATED BY REFERENCE

The disclosure of Japanese Patent Application No. 2008-086134 filed on Mar. 28, 2008 and No. 2008-116627 filed on Apr. 28, 2008, each including the specification, drawings and abstract, are incorporated herein by reference in its entirety.

### BACKGROUND OF THE INVENTION

1. Field of the Invention

The present invention relates to a fluid-filled type vibration-damping device adapted to afford vibration-damping effect based on flow action of a fluid filling the interior.

2. Description of the Related Art

Vibration-damping devices have been employed to provide vibration-damped support of a vibrating body, such as an internal combustion engine, on a base component, such as a vehicle body. For example, the power unit of an automotive vehicle is supported in vibration-damped manner on the vehicle body by a plurality of engine mounts provided as vibration-damping devices.

In the field of automotive engine mounts, highly advanced vibration-damping capabilities are required in order to improve ride comfort. To meet this need, there have been proposed fluid-filled type vibration-damping devices that utilize flow action, e.g. the resonance action, of a non-compressible fluid. As well known, fluid-filled type vibration-damping devices of this kind have a construction in which a pressure-receiving chamber adapted to receive input of vibration and a variable-capacity equilibrium chamber are connected by an orifice passage and filled with a non-compressible fluid. At times of vibration input, vibration-damping effect will be produced on the basis of the resonance action of the non-compressible fluid induced to flow through the orifice passage.

One requirement of an automotive engine mount is that it have vibration-damping capabilities against several different types of vibration that differ, for example, in frequency or amplitude depending on engine speed, vehicle driving conditions and other factors. However, in a high frequency range that exceeds the tuning frequency range of the orifice passage, very high dynamic spring will arise due to antiresonance action, and vibration-damping capabilities will be severely diminished.

To struggle with this problem, a number of liquid pressure absorption mechanisms like that disclosed in U.S. Pat. No. 4,721,292 has been proposed, which has a moveable plate capable of minute displacements disposed between the pressure-receiving chamber and the equilibrium chamber so that the respective pressures of the pressure-receiving chamber and the equilibrium chamber will act upon the respective faces of the moveable plate. However, such a liquid pressure absorption mechanism merely reduces pressure fluctuations arising in the pressure-receiving chamber under conditions in which the orifice passage has become substantially obstructed due to antiresonance, and thus in some instances it has still proven difficult to achieve the required highly advanced vibration-damping capabilities.

More specifically, even where a liquid pressure absorption mechanism is provided, since there is only a single orifice passage, it was difficult to achieve high levels of vibration-damping action against vibration of different frequency ranges, e.g. shaking vibration and idling vibration, through respective fluid resonance. Moreover, even for vibration of the same given frequency, where both large-amplitude vibration and small-amplitude vibration of identical frequency range, such as engine shake during driving of the vehicle and irregular idling vibration (hereinafter termed rough idling vibration) which is unstable at a lower frequency range than the periodic idling vibration (typically secondary idling vibration) associated with explosions of the engine during vehicle idling are input, pressure fluctuations arising in the pressure-receiving chamber at times of small-amplitude vibration input will be escape from the liquid pressure absorption mechanism, making it difficult for the orifice passage to produce effective vibration-damping effect.

To address this problem, there has been proposed, for example in US Publication No. US-2005-0127585-A1, a fluid filled engine mount of externally controlled design, provided with a plurality of orifice passages tuned to different frequencies, with these orifice passages being selectively opened and closed by valves or the like. However, not only is an actuator necessary to carry out switching operations of the valves, but a control unit is also required to generate switching control signals, so construction is unnecessarily complicated and the engine mount per se will be unavoidably larger and more expensive, making it difficult to use.

There has also been proposed, for example Japanese Pat. No. 2811448, a fluid filled engine mount of passive amplitude-dependent switched design having a construction in which a plurality of orifice passages tuned to mutually different frequencies are disposed in parallel between the pressure-receiving chamber and the equilibrium chamber, with moveable plates set to mutually different levels of minute displacement disposed in the orifice passages in the section opening to the pressure-receiving chamber side.

However, a fluid filled engine mount of this conventional amplitude-dependent switched design requires establishing a permissible displacement level differential of a mere 1/10 mm or less for each moveable plate, and given realistic levels of manufacturing accuracy, it will be exceedingly difficult to consistently achieve the desired performance, so this design is not practical either. Another problem is that because the orifice passages are formed in parallel between the pressure-receiving chamber and the equilibrium chamber, at times of input of vibration in the tuning frequency range of one of the orifice passages, pressure fluctuations of the pressure-receiving chamber caused by minute displacements of the other moveable plates disposed on all orifice passages tuned to higher frequency ranges will be absorbed, so vibration-damping effect on the basis of resonance action of the fluid will be diminished.

### SUMMARY OF THE INVENTION

It is therefore one object of the present invention to provide a fluid-filled type vibration-damping device of novel construction that requires no special actuator or control unit, and that efficiently affords high levels of vibration-damping action based on fluid resonance action against each of several types of vibration of different amplitude.

The above objects may be attained according to the following modes of the present invention. The elements employed in the following modes of the invention may be adopted at any possible combinations.

The fluid-filled type vibration-damping device according to the present invention includes: (a) a pressure-receiving chamber whose wall is defined in part by a main rubber elastic body, and that gives rise to pressure fluctuations at times of vibration input and is filled with a non-compressible fluid; (b) a variable-capacity equilibrium chamber whose wall is defined in part by a flexible film and that is filled with a non-compressible fluid; (c) a main orifice passage interconnecting the pressure-receiving chamber and the equilibrium chamber; (d) an intermediate chamber formed separately from the pressure-receiving chamber and the equilibrium chamber and filled with a non-compressible fluid; (e) an input-end moveable plate having restricted deformation, situated on a wall of the intermediate chamber and adapted to undergo displacement in response to pressure from the pressure-receiving chamber directed onto a face on an opposite side from the intermediate chamber so as to transmit pressure from the pressure-receiving chamber to the intermediate chamber and give rise to pressure fluctuations in the intermediate chamber; (f) an output-end moveable plate situated on a different wall from the input-end moveable plate in the intermediate chamber and adapted to transmit pressure fluctuations of the intermediate chamber to the equilibrium chamber to dispel pressure fluctuations of the intermediate chamber, and having restricted deformation such that an amount of capacity variability permitted in association with displacement is smaller than that of the input-end moveable plate; and (g) a sub-orifice passage interconnecting the intermediate chamber and the equilibrium chamber.

In the fluid-filled type vibration-damping device constructed according to the present invention, the intermediate chamber is formed separately from the pressure-receiving chamber and the equilibrium chamber, and combines the main orifice passage, the sub-orifice passage, the input-end moveable plate, and the output-end moveable plate. This arrangement will achieve an amplitude-dependent vibration-damping characteristic switching function that utilizes differences in amplitude of input vibration. That is, utilizing a plurality of moveable plates at the input end and the output end, there is realized a screening action according to amplitude, whereby it is possible to achieve selective function of a plurality of orifice passages in a manner dependent on input vibration amplitude.

More specifically, consider for example hypothetical conditions of input of low-frequency, large-amplitude vibration such as engine shake, medium-frequency, medium-amplitude vibration such as idling vibration, and high-frequency, small-amplitude vibration such as driving rumble. Here, the main orifice is tuned to a low-frequency range such as engine shake, while the sub-orifice passage is tuned to a medium-frequency range such as idling vibration.

In this instance, low-frequency, large-amplitude vibration will give rise in the pressure-receiving chamber to pressure fluctuations that exceed liquid pressure absorption by the input-end moveable plate, and vibration-damping effect against low-frequency, large-amplitude vibration will be achieved on the basis of the resonance action of fluid caused to flow through the main orifice passage. At times of input of medium-frequency, medium-amplitude vibration, pressure fluctuations arising in the pressure-receiving chamber due to the main orifice passage becoming substantially clogged will be transmitted to the intermediate chamber via the input-end moveable plate, and pressure fluctuations that exceed liquid pressure absorption by the output-end moveable plate will be produced in the intermediate chamber so as to realize vibration damping effect against medium-frequency, medium-amplitude vibration, on the basis of the resonance action of fluid caused to flow through the sub-orifice passage. At times of input of high-frequency, small-amplitude vibration, pressure fluctuations exerted from the pressure-receiving chamber on the intermediate chamber via the input-end moveable plate in association with substantial clogging of the main orifice passage and the sub-orifice passage will escape to the equilibrium chamber via the output-end moveable plate, whereby vibration-damping will be afforded through low dynamic spring action. In this way, effective vibration damping of low-frequency, large-amplitude vibration such as engine shake, medium-frequency, medium-amplitude vibration such as idling vibration, and high-frequency, small-amplitude vibration such as driving rumble respectively, will be achieved through vibration-damping characteristics that are switchable on the basis of different amplitude of each type of vibration.

Alternatively, consider for example hypothetical conditions of input of low-frequency, large-amplitude vibration such as engine shake, low-frequency, medium-amplitude vibration such as rough idling vibration, and high-frequency, small-amplitude vibration such as idling vibration. Here, both the main orifice passage and the sub-orifice passage are tuned to a low-frequency range corresponding to engine shake and rough idling vibration. In the instance described previously, idling vibration was termed “medium-frequency, medium-amplitude vibration” in contradistinction to engine shake and driving rumble, but here, it is termed “high-frequency, small-amplitude vibration” in contradistinction to engine shake and driving rumble. In any event, the idling vibration per se is the same, but since “low/medium/high” and “small/medium/large” are relative assessments representing contradistinction to others, there is no inherent contradiction in changing labels in association with different hypothetical conditions.

In this instance, in a similar manner to the hypothetical case above, low-frequency, large-amplitude vibration will give rise to fluid flow through the main orifice passage due to a large pressure fluctuation arising in the pressure-receiving chamber, and vibration-damping action through high damping action will be realized on the basis of the resonance action of this fluid. At times of input of low-frequency, medium-amplitude vibration, since the pressure fluctuations arising in the pressure-receiving chamber in association with input will be small in comparison with low-frequency, large-amplitude vibration, the pressure fluctuations of the pressure-receiving chamber will be transmitted to the intermediate chamber via the input-end moveable plate, and adequate pressure fluctuations will not readily arise in the pressure-receiving chamber, thus making it difficult to ensure the level of fluid flow through the main orifice passage, so that vibration damping effect by the main orifice passage is diminished. However, flow of fluid will be produced through the sub-orifice passage on the basis of pressure fluctuations arising in the intermediate chamber, and the vibration damping effect afforded on the basis of this fluid flow through the sub-orifice passage will be realized in conjunction with the vibration-damping effect based on flow of fluid through the main orifice passage. Thus, high-damping vibration damping effect against low-frequency, medium-amplitude vibration such as rough idling vibration will be realized as well, on the basis of resonance action of the fluid. For high-frequency, small-amplitude vibration such as idling vibration, in a manner comparable to rumble etc. in the hypothetical example above, in association with the main orifice passage and the sub-orifice passage becoming substantially clogged pressure fluctuations exerted from the pressure-receiving chamber on the intermediate chamber via the input-end moveable plate will escape to the equilibrium chamber via the output-end moveable plate, thus affording vibration damping through low dynamic spring action.

In this way, the fluid-filled type vibration-damping device constructed according to the present invention does not require complex and expensive mechanisms such as valves to open and close the orifice passages, actuators to actuate opening and closing thereof, as well as control devices to control actuator operation and so on, but nevertheless effectively affords vibration damping action based on flow action of the sealed fluid, against each of several types of vibration of different amplitude.

In the present invention, it is sufficient for the input-end moveable plate and the output-end moveable plate to be capable of transmitting pressure between the pressure-receiving chamber, the intermediate chamber, and the equilibrium chamber on the basis of elastic deformation or displacement of the plate. Specifically, the input-end moveable plate and the output-end moveable plate may be fabricated of a rubber elastic body of plate form; formed by a plate-shaped body of sufficient rigidity such that it is substantially non-deformable; or have a composite structure of a rubber elastic body anchored to a rigid plate-shaped body. To give a more specific example, it would be possible for the input-end moveable plate and the output-end moveable plate to be constituted by a construction having a rubber elastic body formed sheathing the outside peripheral edge part of a rigid plate-shaped body so that the plate-shaped body is displaceably supported elastically by the rubber elastic body.

In the present invention, no specific limitation is imposed on the construction for making the amount of capacity variability permitted in association with displacement of the output-end moveable plate smaller than the amount of capacity variability permitted in association with displacement of the input-end moveable plate. To give examples of preferred constructions, there could be employed for example a construction adapted to limit the amount of displacement through abutment against the moveable plates when they undergo displacement in the direction of plate thickness, as well as to regulate permissible displacement of the moveable plate in the direction of plate thickness to attain a structure whereby the amount of capacity variability permitted in association with displacement of the output-end moveable plate will be smaller than the amount of capacity variability permitted in association with displacement of the input-end moveable plate. Alternatively, a construction whereby the amount of capacity variability permitted in association with displacement of the output-end moveable plate is made smaller than the amount of capacity variability permitted in association with displacement of the input-end moveable plate could be achieved by making the surface area (effective planar area) of the zone of pressure transmission through displacement or deformation based on pressure action in the output-end moveable plate smaller than the effective planar area of the input-end moveable plate. It would also be possible to combine the former construction involving regulating relative displacement levels of the moveable plates with the latter construction involving regulating relative effective planar area of the moveable plates.

In particular, when imparting to the moveable plates mutually different amounts of capacity variability, by employing the latter construction involving regulating relative effective planar area of the moveable plates and setting the effective planar area of the output-end moveable plate to be smaller than the effective planar area of the input-end moveable plate, design, production, and verification will be easier than where mutually different displacement levels are imparted to the moveable plates, and it will be possible to obtain the desired vibration damping characteristics with higher accuracy.

Further, in the present invention, the main orifice passage and the sub-orifice passage may be tuned to different frequency ranges (as in the former hypothetic case) or tuned to the same frequency range (as in the latter hypothetic case). By tuning them to different frequency ranges, vibration-damping effect based on flow action of fluid induced to flow through the orifice passages can be achieved against vibration of a greater number of different frequency ranges. Alternatively, by tuning them to the same frequency range, vibration-damping effect based on flow action of fluid induced to flow through the orifice passages can be achieved in particular against several types of vibration having different amplitude.

In the present invention, no particular limitation is imposed as to the number of intermediate chambers, and one or several intermediate chambers could be provided.

In particular, in the present invention, where a single intermediate chamber is provided it will be preferable to employ a design wherein the input-end moveable plate is disposed between the pressure-receiving chamber and the intermediate chamber so that pressure of the pressure-receiving chamber will be exerted on one face of the input-end moveable plate while pressure of the intermediate chamber will be exerted on the other face, and giving rise to displacement of the input-end moveable plate on the basis of a pressure differential between the pressure-receiving chamber and the intermediate chamber, whereby pressure fluctuations of the pressure-receiving chamber will be transmitted to the intermediate chamber; and wherein the output-end moveable plate is disposed between the intermediate chamber and the equilibrium chamber so that pressure fluctuations arising in the intermediate chamber will escape to the equilibrium chamber through displacement of the output-end moveable plate on the basis of a pressure differential between the intermediate chamber and the equilibrium chamber.

According to this mode, compact size can be achieved by forming the minimum number of chambers, i.e. the pressure-receiving chamber, the intermediate chamber, and the equilibrium chamber; and situating them adjacently to one another with the input-end moveable plate and the output-end moveable plate between.

In the present invention, where several intermediate chambers are provided, in a preferred arrangement these intermediate chambers will be disposed serially between the pressure-receiving chamber and the equilibrium chamber; and, of any two mutually serially arranged intermediate chambers, the output-end moveable plate provided to a first intermediate chamber that is situated towards the pressure-receiving chamber end will function also as the input-end moveable plate of another intermediate chamber that is situated towards the equilibrium chamber end.

According to this mode, a plurality of intermediate chambers can be utilized to define a plurality of sub-orifice passages that respectively communicate with the equilibrium chamber. Through appropriate tuning of the plurality of sub-orifice passages it will be possible to achieve effective vibration damping effect equivalent to a wider range, against a wider frequency range of vibration and against vibration of differing amplitude. Moreover, by serially arranging the plurality of intermediate chambers with the moveable plates between them, the increase in size of the vibration-damping device as a whole can be kept to a minimum.

As will be appreciated from the above, regardless of whether one or several intermediate chambers are provided, the input-end moveable plate and the output-end moveable plate will preferably be established such that their displacement direction (which is also the thickness direction) is the same; and preferably such that this displacement direction coincides with the direction of input of principal vibration to be damped. By so doing, the efficiency of pressure transmission by the moveable plates can be further improved.

In another preferred mode of the invention, at least one of the input-end moveable plate and the output-end moveable plate is composed of a moveable plate member comprising a rigid constraining plate sheathed with film-like rubber, the constraining plate having irregular shape of varying outside diameter dimension in a circumferential direction and provided with alternating small-diameter portions and large-diameter portions in the circumferential direction; sections defining the small-diameter portions of the constraining plate constitute elastic film portions composed of single-layer structure of film-like rubber; a plurality of elastic contacting projections that project out to either side in a plate thickness direction are integrally formed in the elastic film portions that have been provided at multiple locations along a circumference of an outside peripheral section of the moveable plate member, the plurality of elastic contacting projections being adapted to come into initial contact with a partition member which parts the pressure-receiving chamber and the equilibrium chamber from each other during displacement of the moveable plate member in the plate thickness direction; restraining elastic ribs that connect in the circumferential direction with the plurality of elastic contacting projections and that extend in the circumferential direction through the outside peripheral section of the moveable plate member are integrally formed with the elastic film portions in the large-diameter portions of the constraining plate, with the restraining elastic ribs being adapted to come into contact against the partition member after the elastic contacting projections do during displacement of the moveable plate member in the plate thickness direction; and inward-extending ribs that extend diametrically inward on the large-diameter portions of the constraining plate are formed at multiple locations along a circumference of the restraining elastic ribs, with the inward-extending ribs adapted to also come into contact against the partition member during displacement of the moveable plate member in the plate thickness direction.

Where this moveable plate member is used as the input-end moveable plate, inward-extending ribs that extend in the diametrical direction project up from the surface of the outside peripheral section of the moveable plate member, and these inward-extending ribs afford a flow-rectifying action of fluid flow that arises at the surface of the moveable plate member in association with displacement of the moveable plate member. This flow-rectifying action will have the effect of reducing fluid resistance to displacement of the moveable plate member and fluid flow resistance produced at the perimeter of the moveable plate member, thereby more effectively assuring both sufficient fluid flow through the sub-orifice passage in association with displacement of the moveable plate member as described above, and sufficient flow of fluid around to the outside peripheral side of the moveable plate member and through the sub-orifice passage.

In addition to the featured arrangements described above the fluid-filled vibration-damping device according to the present invention may further employ an arrangement whereby for example, on the large-diameter sections of the constraining plate, the restraining elastic ribs are formed so as to extend in the circumferential direction along an outside peripheral edge part of the large-diameter section, while the inward-extending ribs are formed so as to extend in a diametrical direction along both circumferential side edge parts of the large-diameter section.

According to this construction, the restraining elastic ribs and the inward-extending ribs may be arranged efficiently on the outside peripheral edge section furthest away from the center in the constraining plate. As a result, through contact of the restraining elastic ribs and the inward-extending ribs against the partition member it will be possible for the constraining plate as a whole to experience regulated displacement in balanced manner with high strength.

In addition to the featured arrangements described above, the fluid-filled vibration-damping device according to the present invention may further employ an arrangement whereby for example, both the restraining elastic ribs and the inward-extending ribs project out to both sides in the plate thickness direction from the constraining plate, with smaller height dimension as compared to the elastic contacting projections.

According to this construction, it will be possible for the entire contacting face of the moveable plate member on the side thereof lying towards the partition member contacted by the elastic contacting projections, the restraining elastic ribs, and the inward-extending ribs to be defined by a planar shape that is orthogonal to the plate thickness direction, which is also the direction of displacement of the moveable plate member.

### BRIEF DESCRIPTION OF THE DRAWINGS

The foregoing and/or other objects features and advantages of the invention will become more apparent from the following description of a preferred embodiment with reference to the accompanying drawings in which like reference numerals designate like elements and wherein:

FIG. 1 is an vertical cross sectional view of a fluid filled type vibration damping device in the form of an engine mount according to the first embodiment;

FIG. 2 is a schematic view of the engine mount of FIG. 1;

FIG. 3 is a schematic view for explaining functional structure of the engine mount upon input of low-frequency, large-amplitude vibration;

FIG. 4 is a schematic view for explaining functional structure of the engine mount upon input of medium-frequency, medium-amplitude vibration;

FIG. 5 is a schematic view for explaining functional structure of the engine mount upon input of high-frequency, small-amplitude vibration;

FIG. 6 is a graph showing the frequency characteristics of the damping coefficient in the low-frequency range in the present engine mount;

FIG. 7 is a graph showing the frequency characteristics of the damping coefficient in the low-frequency range in the conventional engine mount;

FIG. 8 is a schematic view of another fluid-filled type vibration damping device of the present invention in the form of an engine mount where two intermediate chambers are serially arranged between the pressure-receiving chamber and the equilibrium chamber;

FIG. 9 is a top plane view of a moveable plate member usable as an input-end moveable plate and/or an output-end moveable plate of the engine mount of FIG. 1;

FIG. 10 is a bottom plane view of the moveable plate member of FIG. 9;

FIG. 11 is a cross sectional view taken along line 11-11 of FIG. 9;

FIG. 12 is a cross sectional view taken along line 12-12 of FIG. 9; and

FIG. 13 is a top plane view of a constraining plate of the moveable plate member of FIG. 9.

### DETAILED DESCRIPTION OF PREFERRED EMBODIMENTS

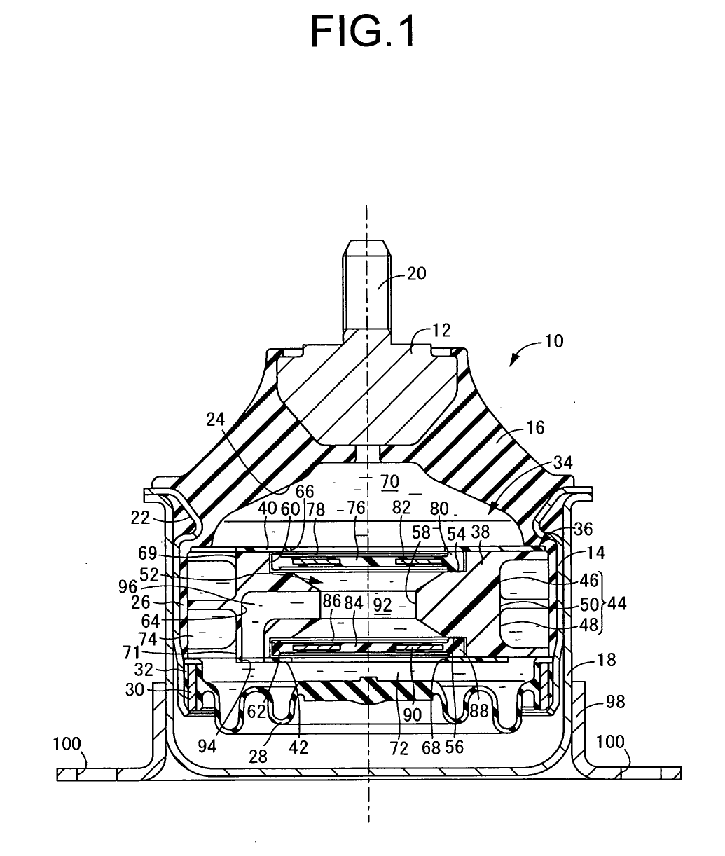

FIG. 1 depicts an automotive engine mount 10 as a first embodiment of a fluid-fluid type vibration damping device according to the present invention. This automotive engine mount 10 has a construction in which a first mounting member 12 and a second mounting member 14 are linked by a main rubber elastic body 16. The first mounting member 12 is mounted to a power unit (not shown), while the second mounting member 14 is mounted onto the vehicle body (not shown) via a tubular bracket 18, so that the power unit is supported in a vibration-damped manner on the vehicle body. In the description herein, the vertical direction shall as general rule refer to the vertical direction in FIG. 1.

To describe in greater detail, the first mounting member 12 is fabricated of metal material such as iron or aluminum alloy, and has an overall shape resembling an inverted truncated cone. At the large-diameter end face of the first mounting member 12, there is integrally formed a mounting bolt 20 that projects upward in the axial direction.

Meanwhile, like the first mounting member 12, the second mounting member 14 is fabricated of metal material such as iron or aluminum alloy, and it has an overall shape resembling a large-diameter round tube. At the axial upper end part of the second mounting member 14 there is formed a constricted portion 22 that takes the form of a groove recessed diametrically inward and extending continuously in the circumferential direction.

The first mounting member 12 is arranged spaced apart from the axial upper opening side of the second mounting member 14 constructed in the above manner, and the members are positioned on approximately the same center axis. The main rubber elastic body 16 is arranged between the first mounting member 12 and the second mounting member 14, so that the first mounting member 12 and the second mounting member 14 are elastically linked by the main rubber elastic body 16.

The main rubber elastic body 16 has a generally truncated cone shape overall, with large-diameter recess 24 of inverted bowl shape opening downward at its large-diameter end face. The first mounting member 12 is inserted into the small-diameter end of the main rubber elastic body 16 and is embedded therein by vulcanization bonding; while the axial upper opening of the second mounting member 14 is juxtaposed against the outside peripheral face of the large-diameter end of the main rubber elastic body 16 and vulcanization bonded to it. As will be appreciated from the above, in the present embodiment, the main rubber elastic body 16 is provided as an integrally vulcanization molded component that incorporates the first mounting member 12 and the second mounting member 14. Also, in the present embodiment, the constricted portion 22 in its entirety is positioned on the outside peripheral face of the main rubber elastic body 16, and a rubber elastic body that is integrally formed with the main rubber elastic body 16 is anchored to and fills in the outside peripheral side of the constricted portion 22.

By vulcanization bonding the opening of the second mounting member 14 to the outside peripheral face of the main rubber elastic body 16 in this way, the opening at the axial upper end of the second mounting member 14 will be covered fluid-tightly by the main rubber elastic body 16.

The inside peripheral face of the second mounting member 14 is sheathed by a seal rubber layer 26. This seal rubber layer 26 is integrally formed with the main rubber elastic body 16, and has thin-walled tubular contours extending downward from the rim part of the opening of the large-diameter recess 24. In the present embodiment in particular, the seal rubber layer 26 sheathes the second mounting member 14 for a prescribed distance starting from the lower side of the constricted portion 22.

A flexible film 28 is attached to the second mounting member 14 so as to cover its opening on the lower side in the axial direction. The flexible film 28 is made of thin rubber film, and has generally circular disk shape imparted with waviness of rippled appearance.

A fastener fitting 30 of round tubular shape is vulcanization bonded to the outside peripheral edge part of the flexible film 28. In this embodiment in particular, the outside peripheral edge part of the flexible film 28 extends from the upper edge of the fastener fitting 30 to the outside peripheral face of the fastener fitting 30. Through this arrangement, a seal rubber layer 32 that is integrally formed with the flexible film 28 will sheath the upper edge face and outside peripheral face of the fastener fitting 30.

With the fastener fitting 30 fitted into the lower end part of the second mounting member 14, the second mounting member 14 will be subjected to a diameter-reduction process such as 360-degree or eight-die using radial compression so that the flexible film 28 constructed in this way becomes secured within the axial lower end part of the second mounting member 14.

By attaching the flexible film 28 to the second mounting member 14 in this way, the opening at the axial upper end of the second mounting member 14 will be closed off fluid-tightly by the main rubber elastic body 16, while the opening at the axial lower end of the second mounting member 14 will be covered fluid-tightly by the flexible film 28. Thus, to the inside of the second mounting member 14 and axially between the main rubber elastic body 16 and the flexible film 28 there will be defined a fluid chamber 34 that is sealed off from the outside. This fluid chamber 34 is filled with a non-compressible fluid such as water, an alkylene glycol, a polyalkylene glycol, silicone oil, or the like. Filling of the fluid chamber 34 with non-compressible fluid may be accomplished advantageously by attaching the flexible film 28 and a partition member 36 (discussed later) to the integrally vulcanization molded component of the main rubber elastic body 16 incorporating the first mounting member 12 and the second mounting member 14, while these components are submerged in the non-compressible fluid.

The partition member 36 is housed within the fluid chamber 34. The partition member 36 has circular block shape overall, and is composed of a partition member main body 38, an upper partition plate 40 juxtaposed against the upper end face of the partition member main body 38, and a lower partition plate 42 juxtaposed against the lower end face of the partition member main body 38.

The partition member main body 38 is made of rigid synthetic resin material and has circular block shape overall. In the outside peripheral section of the partition member main body 38, there is formed a circumferential groove 44 that opens onto the outside peripheral face and extends for a distance just short of twice around the circumference. In the present embodiment, the circumferential groove 44 which opens onto the outside peripheral face and extends for a distance just short of twice around the circumference is defined by connecting together, via a connecting hole 50, a first circumferential end of an upper circumferential groove 46 that opens onto the outside peripheral face on the upper end side and extends for a distance just short of full circle in the circumferential direction, and the other circumferential end of a lower circumferential groove 48 that opens onto the outside peripheral face on the lower end side and extends for a distance just short of full circle in the circumferential direction.

A center hole 52 of circular cross section passing in the axial direction through the diametrical center section of the partition member main body 38. In the present embodiment, shoulder faces 54, 56 of annular contours extending in the axis-perpendicular direction are respectively formed on the inside peripheral face of this center hole 52, in proximity to its axial ends. Thus, the axial medial section of the center hole 52 will define a small-diameter portion 58, while the axial end sections will define large-diameter portions 60, 62. In the present embodiment, the upper large-diameter portion 60 formed on the axial upper side and the lower large-diameter portion 62 formed on the axial lower side have identical axial dimension and identical diameter dimension.

Also, in the present embodiment, tapered faces of gradually flared diameter moving outwardly in the axial direction are formed on the inside peripheral face of the small-diameter portion 58 of the center hole 52, at the respective axial ends. Consequently, the small-diameter portion 58 of the center hole 52 will have its smallest diameter dimension in this axial medial section.

Furthermore, a communication passage 64 that opens onto the inside peripheral face of the axial medial section of the small-diameter portion 58 of the center hole 52 (i.e. the section of smallest diameter dimension in the center hole 52) and onto the lower end face of the partition member main body 38 is formed in the partition member main body 38 in anywhere but the locations of the circumferential groove 44 and the center hole 52. The passage length of this communication passage 64 will be sufficiently shorter than the length of the circumferential groove 44 in the groove direction.

The upper partition plate 40 is made of rigid synthetic resin material and has annular plate shape with a center hole 66. In the present embodiment, the outside diameter dimension of the upper partition plate 40 is smaller than the outside diameter dimension of the partition member main body 38, but larger than the inside diameter dimension of the opening end of the large-diameter recess 24 that opens onto the large-diameter end face of the main rubber elastic body 16. Also, in the present embodiment the inside diameter dimension of the upper partition plate 40 is smaller than the inside diameter dimension of the upper large-diameter portion 60 formed of the center hole 52 which has been provided to the partition member main body 38.

The lower partition plate 42 is made of rigid synthetic resin material and has annular plate shape with a center hole 68. In the present embodiment, the outside diameter dimension of the lower partition plate 42 is adequately smaller than the outside diameter dimension of the partition member main body 38. Meanwhile, the inside diameter dimension of the lower partition plate 42 is smaller than the inside diameter dimension of the lower large-diameter portion 62 of the center hole 52 which has been provided to the partition member main body 38.

The partition member main body 38, the upper partition plate 40, and the lower partition plate 42 having the construction described above are assembled together to produce the partition member 36 by juxtaposing the upper partition plate 40 against the upper end face of the partition member main body 38 and aligning it on the same center axis as the partition member main body 38; juxtaposing the lower partition plate 42 against the lower end face of the partition member main body 38 and aligning it on the same center axis as the partition member main body 38; and securing these in place with machine screws (not shown), or by ultrasonic welding or the like. By producing the partition member 36 in this way, the upper large-diameter portion 60 and the lower large-diameter portion 62 will define annular recesses of mutually identical dimensions having circular shape that open diametrically inward and extend continuously about the entire circumference in the circumferential direction.

The partition member 36 having the above construction will be arranged between the axially opposed faces of the main rubber elastic body 16 and the flexible film 28, to the inside of the second mounting member 14.

Specifically, prior to attaching the flexible film 28 to the second mounting member 14, the partition member 36 will be slipped into the second mounting member 14 through its axial lower opening and positioned to the inside of the second mounting member 14. During this process, the outside peripheral edge part of the upper partition plate 40 is positioned between the outside peripheral edge of the upper end of the partition member main body 38 and the opening end face of the large-diameter recess 24 that has been formed in the main rubber elastic body 16.

In this state, the flexible film 28 will be slipped in from below in the axial direction and juxtaposed against the partition member 36 from below. During this process, the fastener fitting 30 of the flexible film 28 will be positioned in abutment against the outside peripheral edge part of the lower end face of the partition member main body 38 via the intervening seal rubber layer 32.

Then, with the partition member 36 and the flexible film 28 thusly inserted, the second mounting member 14 will be subjected to a diameter-reduction process such as eight-die using or 360-degree radial compression in order to secure the partition member 36 and the flexible film 28 fitted inside the second mounting member 14. During this process, the upper partition plate 40 is held with its outside peripheral edge part clasped between the outside peripheral edge part of the upper end of the partition member main body 38 and the opening end face of the large-diameter recess 24 that has been formed in the main rubber elastic body 16, thereby securing it to the partition member main body 38.

In the present embodiment, the outside peripheral face of the partition member 36 is juxtaposed against the inside peripheral face of the second mounting member 14 via the intervening seal rubber layer 26, thereby providing a fluid-tight seal between the second mounting member 14 and the partition member 36. In the present embodiment, when the second mounting member 14 is subjected to diameter reduction, the amount of diameter reduction in the section within which the flexible film 28 fits will be greater than that in the section within which the partition member 36 fits. Thus, fastening of the partition member 36 and the flexible film 28 can be accomplished effectively while preventing damage to the synthetic resin partition member 36. Furthermore, during diameter reduction of the second mounting member 14, the tapered tube contour at the lower end of the second mounting member 14, which is progressively smaller in diameter towards the bottom, will prevent the flexible film 28 from slipping out through the bottom.

With the partition member 36 in this assembled state, the fluid chamber 34 is bifurcated into upper and lower parts by the partition member 36, thereby forming to one axial side of the partition member 36 a pressure-receiving chamber 70 whose wall is defined in part by the main rubber elastic body 16 and that gives rise to internal pressure fluctuations at times of vibration input; and forming to the other axial side of the partition member 36 an equilibrium chamber 72 whose wall is defined in part by the flexible film 28 and that readily allows changes in capacity.

The opening at the outside peripheral side of the circumferential groove 44 that has been formed in the partition member 36 is covered by the second mounting member 14 via the intervening seal rubber layer 26, thereby defining a tunnel-like passage utilizing the circumferential groove 44 and that extends for a prescribed distance in the circumferential direction. This tunnel-like passage connects at one end to the pressure-receiving chamber 70 through a communication hole 69, and at the other end to the equilibrium chamber 72 through a communication hole 71. There is thereby defined a main orifice passage 74 utilizing the circumferential groove 44 that interconnects the pressure-receiving chamber 70 and the equilibrium chamber 72. In the present embodiment, the resonance frequency (tuning frequency) of fluid induced to flow through the main orifice passage 74 will be tuned to a low frequency range of around 10 Hz, equivalent to engine shake or rough idling vibration of an automotive vehicle.

An input-end moveable plate 76 is arranged within the upper large-diameter portion 60 of the center hole 52 that has been formed in the partition member main body 38. The input-end moveable plate 76 is made of conventional known rubber material, and has an overall shape of a thick circular disk.

In the present embodiment, at the outside peripheral edge part of the input-end moveable plate 76, there is formed a rib projection 78 that juts out to either side in the thickness direction and extend about the entire circumference. In the present embodiment, at the outside peripheral edge part of the input-end moveable plate 76, there are also formed a plurality of supporting projections 80 that jut out with projecting height exceeding the projecting height of the rib projection 78, and that jut diametrically inward from the inside peripheral face of the rib projection 78 are formed with appropriate spacing in the circumferential direction.

In the present invention moreover, a reinforcing fitting 82 made of metal material such as iron or aluminum alloy and having annular plate shape is embedded into the input-end moveable plate 76. Alternatively, a reinforcing plate of some other material such as synthetic resin could be employed in place of the reinforcing fitting 82. Any material that is more rigid than the rubber elastic body that forms the rib projection 78 etc. would be acceptable.

The input-end moveable plate 76 constructed as described above, with the plurality of supporting projections 80 provided in its outside peripheral edge part held clasped between the inside peripheral edge part of the upper partition plate 40 and the upper shoulder face 54 that has been formed on the inside peripheral face of the center hole 52, will be housed within the upper large-diameter portion 60 so as to extend in the axis-perpendicular direction on an axis coincident with the center axis of the upper large-diameter portion 60. The upper face of the input-end moveable plate 76 will thereby be situated exposed to the pressure-receiving chamber 70 through the center hole 66 of the upper partition plate 40, while the lower face of the input-end moveable plate 76 will be situated above the upper opening of the small-diameter portion 58 of the center hole 52 and extend so as to cover this upper opening.

With the input-end moveable plate 76 arranged accommodated inside the upper large-diameter portion 60 as described above, gaps will be respectively defined between the upper partition plate 40 and the upper edge face of the rib projection 78 of the input-end moveable plate 76, between the upper shoulder face 54 and the lower end face of the rib projection 78 of the input-end moveable plate 76, and between the inside peripheral face of the upper large-diameter portion 60 and the outside peripheral face of the input-end moveable plate 76. The input-end moveable plate 76 will thereby be situated accommodated inside the upper large-diameter portion 60, in a condition that allows the plate as a whole to undergo displacement in the plate thickness direction, except in those sections where the plurality of supporting projections 80 have been formed.

That is, the input-end moveable plate 76 of the present embodiment is adapted to allow its center section in which the reinforcing fitting 82 is anchored to undergo displacement in the plate thickness direction through elastic deformation of its outside edge part where the plurality of supporting projections 80 have been formed. Moreover, the level of permitted displacement by this center section in the plate thickness direction will be limited in a cushioned manner by spring rigidity at the outside peripheral edge of the input-end moveable plate 76. Furthermore, in the event that the input-end moveable plate 76 is acted upon by an even higher level of pressure, the outside peripheral part of the input-end moveable plate 76 will come into abutment against the inside face of the widthwise side wall portions of the aforementioned annular recess that defines the upper large-diameter portion 60, thereby mechanically limiting the extent of displacement of the input-end moveable plate 76 and preventing it from being damaged. However, the gaps described above are not an essential element of the present invention, and it would also be acceptable, for example, for the outside peripheral part of the input-end moveable plate 76 to be arranged in a condition with its entire circumference abutted against the opposing inside face of the upper large-diameter portion 60 through an annular elastic projection.

The output-end moveable plate 84 is arranged inside the lower large-diameter portion 62 of the center hole 52 that has been formed in the partition member main body 38. In the present embodiment, this output-end moveable plate 84 has shape and dimensions substantially identical to the input-end moveable plate 76 discussed earlier. In the present embodiment however, the material forming the output-end moveable plate 84 is different from the material forming the input-end moveable plate 76. Thus, the elasticity of output-end moveable plate 84 and the ease of displacement of the input-end moveable plate 76 in the plate thickness direction will differ. Specifically, the output-end moveable plate 84 will have greater rubber hardness and greater spring rigidity than the input-end moveable plate 76, so that displacement in the plate thickness direction when acted upon by identical pressure will be limited to a smaller amount for the output-end moveable plate 84 than for the input-end moveable plate 76.

In the drawings, symbol 86 assigned to the output-end moveable plate 84 denotes a rib projection that corresponds to symbol 78 of the input-end moveable plate 76; symbol 88 denotes a supporting projection that corresponds to symbol 80 of the input-end moveable plate 76; and symbol 90 denotes a reinforcing fitting that corresponds to symbol 82 of the input-end moveable plate 76.

The output-end moveable plate 84 constructed as above will be arranged accommodated within the lower large-diameter portion 62, with the plurality of supporting projections 88 at its outside peripheral edge part held clasped between the lower shoulder face 56 that has been formed on the inside peripheral face of the center hole 52 and the inside peripheral edge part of the lower partition plate 42. The upper face of the output-end moveable plate 84 will thereby be positioned below the lower opening of the small-diameter portion 58 of the center hole 52 and will extend so as to cover the lower opening, while the lower face of the output-end moveable plate 84 will be positioned exposed to the equilibrium chamber 72 through the center hole 68 of the lower partition plate 42.

With the output-end moveable plate 84 arranged accommodated inside the lower large-diameter portion 62 as described above, gaps will be respectively defined between the lower shoulder face 56 and the upper end face of the rib projection 86 of the output-end moveable plate 84, between the lower partition plate 42 and the lower end face of the rib projection 86 of the output-end moveable plate 84, and between the outside peripheral face of the output-end moveable plate 84 and the inside peripheral face of the lower large-diameter portion 62. However, these gaps are not an essential element of the present invention, and a mode of arrangement comparable to that of the input-end moveable plate 76 could be employed.

An intermediate chamber 92 filled with non-compressible fluid is defined between the opposed faces of the input-end moveable plate 76 and the output-end moveable plate 84, inside the center hole 52 of the partition member main body 38 in which the input-end moveable plate 76 and the output-end moveable plate 84 have been arranged as described above.

Pressure of the pressure-receiving chamber 70 will be exerted on the upper face of the input-end moveable plate 76 through the center hole 66 of the upper partition plate 40, while pressure of the intermediate chamber 92 will be exerted on the lower face of the input-end moveable plate 76. As a result, based on a pressure differential between the pressure-receiving chamber 70 and the intermediate chamber 92, the input-end moveable plate 76 will experience elastic displacement in the plate thickness direction so that pressure fluctuations of the pressure-receiving chamber 70 are transmitted to the intermediate chamber 92.

Additionally, pressure of the intermediate chamber 92 will be exerted on the upper face of the output-end moveable plate 84, while pressure of the equilibrium chamber 72 will be exerted on the lower face of the output-end moveable plate 84 through the center hole 68 of the lower partition plate 42. As a result, based on a pressure differential between the intermediate chamber 92 and the equilibrium chamber 72, the output-end moveable plate 84 will experience elastic displacement in the plate thickness direction so that pressure fluctuations of the intermediate chamber 92 escape to the equilibrium chamber 72.

In the present embodiment, the output-end moveable plate 84 has greater displacement rigidity than does the input-end moveable plate 76, while the output-end moveable plate 84 and the input-end moveable plate 76 are substantially identical in shape and size. Thus, when subjected to pressure of a given magnitude, the amount of elastic deformation of the output-end moveable plate 84 will be smaller than the amount of elastic deformation of the input-end moveable plate 76. That is, the amount of capacity change of the intermediate chamber 92 permitted on the basis of deformation of the output-end moveable plate 84 will be smaller than the amount of capacity change of the intermediate chamber 92 permitted on the basis of deformation of the input-end moveable plate 76.

Owing to this fact, when vibration is input across the first mounting member 12 and the second mounting member 14 in the direction of the mount axis (the axial direction indicated by the dot-and-dash line in FIG. 1), pressure fluctuations will arise in the pressure-receiving chamber 70, and because of these pressure fluctuations the input-end moveable plate 76 will experience displacement in the plate thickness direction so that the pressure fluctuations are transmitted to the intermediate chamber 92. While these pressure fluctuations in the intermediate chamber 92 would ordinarily give rise to displacement of the output-end moveable plate 84, because the displacement rigidity of the output-end moveable plate 84 is greater than the displacement rigidity of the input-end moveable plate 76, escape of pressure arising in the intermediate chamber 92 in association with displacement of the output-end moveable plate 84 will be limited, as a result of which pressure fluctuations will be effectively produced in the intermediate chamber 92.

The communication passage 64 which has been formed in the partition member main body 38 connects at one end to the intermediate chamber 92, and at its other end to the equilibrium chamber 72 through a communication hole 94. Thus, utilizing the communication passage 64, there is defined a sub-orifice passage 96 that interconnects the intermediate chamber 92 and the equilibrium chamber 72. In the present embodiment, the resonance frequency (tuning frequency) of fluid induced to flow through the sub-orifice passage 96 will be tuned to a middle frequency range of around 15 to 30 Hz, equivalent to idling vibration of an automotive vehicle.

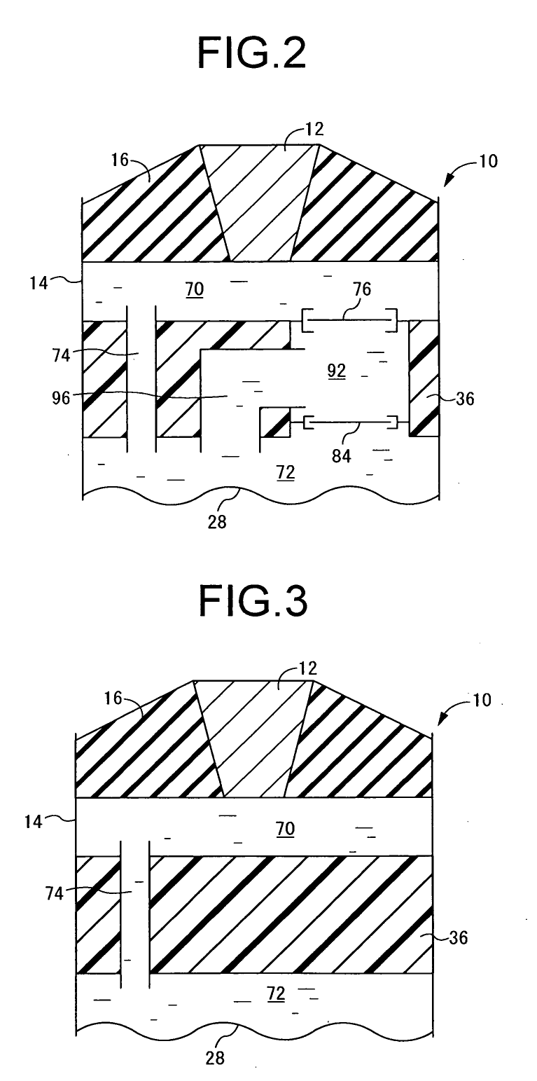

FIG. 2 depicts in model form a simplified design of an engine mount 10 constructed in this way. As shown in the drawing, the amount of capacity change allowed by deformation of the input-end moveable plate 76 is greater than the amount of capacity change allowed by deformation of the output-end moveable plate 84. In the embodiment above, the amount of allowed displacement of the output-end moveable plate 84 in the plate thickness direction is set to a level smaller than the amount of allowed displacement of the input-end moveable plate 76 in the plate thickness direction, based on a difference between spring rigidity of the rubber elastic body forming the input-end moveable plate 76 and spring rigidity of the rubber elastic body forming the output-end moveable plate 84. However, in the model diagram of FIG. 2, in order to facilitate understanding the difference in relative amount of allowed capacity change between the input-end moveable plate 76 and the output-end moveable plate 84 has been represented in terms of size of gap dimensions rather than by spring rigidity.

The engine mount 10 constructed as above will be mounted onto the power unit by screw-fastening the first mounting member 12 to a mounting member on the power unit side with the mounting bolt 20. Meanwhile, the second mounting member 14 will be mounted onto the vehicle body by passing fastening bolts (not shown) through bolt passage holes 100 provided in a mounting leg portion 98 provided to the tubular bracket 18 that has been secured fitting about the outside of the second mounting member 14, and screw-fastening the bolts to the vehicle body. By so doing, the engine mount 10 will be interposed between the power unit constituting one component of a vibration-damped linkage and the vehicle body constituting the other component of a vibration-damped linkage, and will provide vibration-damped support of the power unit on the vehicle body.

With this engine mount 10 installed in an automotive vehicle, the distributed support load of the power unit will be directed across the first mounting member 12 and the second mounting member 14 in approximately the axial direction, thereby causing the main rubber elastic body 16 to undergo elastic deformation by a prescribed amount, and inducing displacement of the first mounting member 12 and the second mounting member 14 closer together by a prescribed amount.

With the engine mount 10 constructed as described above installed in an automotive vehicle, when low-frequency, large amplitude vibration such as engine shake which can be a problem during driving is input, pressure fluctuations of large amplitude will be produced in the pressure-receiving chamber 70. At this time, displacement will occur on the basis of elastic deformation of the input-end moveable plate 76. However, parameters such as the elasticity of the input-end moveable plate 76 have been set such that displacement of the input-end moveable plate 76 within a limited range will not be sufficient to effectively absorb the pressure fluctuations in the pressure-receiving chamber 70.

Consequently, during input of low-frequency, large-amplitude vibration, the input-end moveable plate 76 and the intermediate chamber 92 will assume a substantially nonfunctioning condition, and in association with this substantially no fluid flow will be produced through the sub-orifice passage 96. FIG. 3 is a model depiction of a functional arrangement of the engine mount 10 in this condition.

Specifically, in this arrangement, under such conditions the pressure-receiving chamber 70 to which vibration is input and the variable-capacity equilibrium chamber 72 will be connected by the main orifice passage 74 which has been tuned to a low-frequency range. For this reason, an ample level of fluid flow through the main orifice passage 74 due to relative pressure fluctuations arising between the pressure-receiving chamber 70 and the equilibrium chamber 72 at times of vibration input will be effectively assured; and effective vibration damping action against low-frequency, large amplitude vibration such as engine shake will be afforded on the basis of the resonance action of fluid induced to flow through the main orifice passage 74.

At times of input of low-frequency, medium-amplitude vibration such as rough idling vibration which can be a problem with the car at a stop, pressure fluctuations of moderately large amplitude will be produced in the pressure-receiving chamber 70, though this amplitude will be smaller than that of pressure fluctuations produced at times of input of low-frequency, large amplitude vibration such as engine shake. At this time as well, the limited range of displacement established for the input-end moveable plate 76 is such that there will be substantially no pressure absorbing action of the pressure-receiving chamber 70, and as a result, vibration damping action (high-damping effect) will be realized effectively by the main orifice passage 74, in a manner comparable to the case of engine shake.

Meanwhile, at times of input of medium-frequency, small-amplitude vibration such as normal idling vibration (cyclical idling fundamental vibration such as secondary idling vibration of engine explosions) which can be a problem with the car at a stop, because the level of pressure fluctuations arising in the pressure-receiving chamber 70 is small, pressure fluctuations of the pressure-receiving chamber 70 will be transmitted to the intermediate chamber 92 through displacement of the input-end moveable plate 76 within the allowable range. Thus, even if the main orifice passage 74 has become substantially blocked off, it will be possible to avoid excessive pressure in the pressure-receiving chamber 70; as well as to transmit pressure fluctuations of the pressure-receiving chamber 70 to the intermediate chamber 92 and produce effective pressure fluctuations in the intermediate chamber 92.

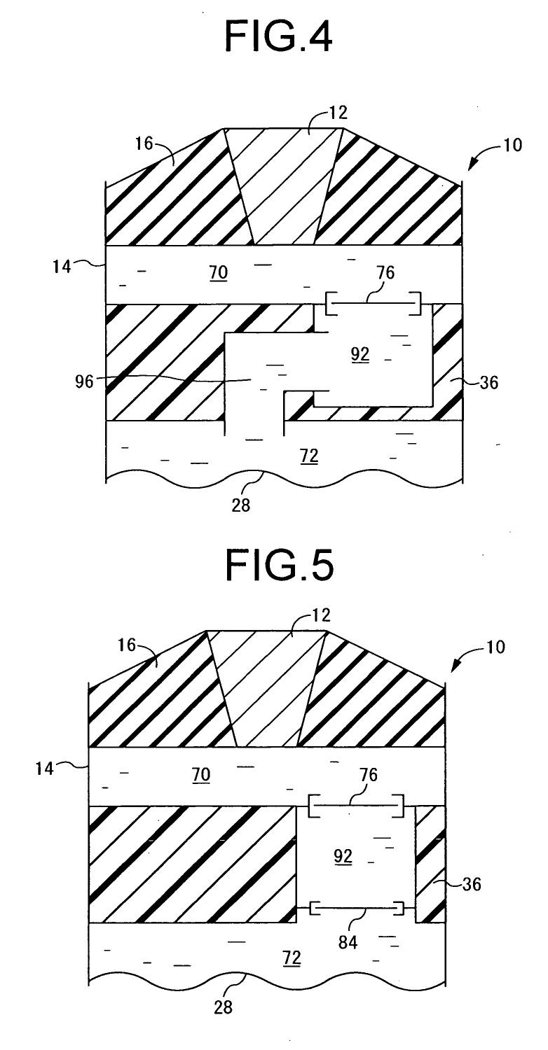

At this time, the displacement rigidity of the output-end moveable plate 84 has been set such that the allowed amount of displacement of the output-end moveable plate 84 is insufficient for pressure fluctuations of the intermediate chamber 92 to be absorbed. Thus, pressure fluctuations of the intermediate chamber 92 will not escape to the equilibrium chamber 72, so fluid flow will be produced efficiently through the sub-orifice passage 96. FIG. 4 is a model depiction of a functional arrangement of the engine mount 10 in this condition.

Specifically, in this arrangement, under such conditions the intermediate chamber 92 (in which effective pressure fluctuations comparable to the pressure-receiving chamber 70 are produced) and the variable-capacity equilibrium chamber 72 will be connected by the sub-orifice passage 96 which has been tuned to a medium-frequency range. For this reason, an ample level of fluid flow through the sub-orifice passage 96 due to relative pressure fluctuations arising between the pressure-receiving chamber 70, the intermediate chamber 92, and the equilibrium chamber 72 at times of vibration input will be effectively assured; and effective vibration damping action (vibration isolation effect based on low dynamic spring action) against idling fundamental vibration will be afforded on the basis of the resonance action of fluid induced to flow through the sub-orifice passage 96.

At times of input of high-frequency, small-amplitude vibration such as drive rumble or booming noise which can be a problem during driving, pressure fluctuations of small amplitude will be produced in the pressure-receiving chamber 70. The level of pressure fluctuation arising in the pressure-receiving chamber 70 will be approximately equal to or less than the allowable pressure fluctuation level based on elastic deformation of the input-end moveable plate 76, and also equal to or less than the allowable pressure fluctuation level based on elastic deformation of the output-end moveable plate 84. Thus, pressure fluctuations of the pressure-receiving chamber 70 will be transmitted to the intermediate chamber 92, and pressure fluctuations of the intermediate chamber 92 will escape to the equilibrium chamber 72.

Moreover, during input of high-frequency, small-amplitude vibration, both the main orifice passage 74 and the sub-orifice passage 96 will experience very high levels of fluid flow resistance due to antiresonance action and will become substantially blocked off. FIG. 5 is a model depiction of a functional arrangement of the engine mount 10 in this condition.

Specifically, under these conditions, pressure fluctuations of the pressure-receiving chamber 70 will escape to the equilibrium chamber 72, thereby mitigating or avoiding high dynamic spring resulting from substantial blocking off of the main and sub-orifice passages 74, 96, so that good vibration damping effect (vibration isolation effect based on low dynamic spring characteristics) will be realized against high-frequency, small-amplitude vibration.

Consequently, in the engine mount 10 having the construction described above, vibration damping effect based on resonance action of fluid can be effectively realized against each of several types of vibration of different amplitude, without the need to provide an actuator or control device.

In the engine mount 10 of the present embodiment, tuning of the main orifice passage 74 and the sub-orifice passage 96, as well as tuning of the input-end moveable plate 76 and the output-end moveable plate 84, is not limited to the mode described previously. Another specific tuning mode will be described below.

Specifically, the resonance frequency (tuning frequency) of fluid caused to flow through the sub-orifice passage 96 will be tuned to a low frequency range of around 10 Hz, which corresponds to rough idling vibration. Thus, in this mode the tuning frequency of the main orifice passage 74 and the tuning frequency of the sub-orifice passage 96 will be set to the same frequency range.

Concomitantly, the amount of allowable displacement of the input-end moveable plate 76 will be set to a level greater than in the preceding embodiment so as to enable sufficient following of pressure fluctuations arising in the pressure-receiving chamber 70 at times of input of rough idling vibration, so that these pressure fluctuations of the pressure-receiving chamber 70 may be transmitted to the intermediate chamber 92. Also, the amount of allowable displacement of the output-end moveable plate 84 will be set to a level greater than in the preceding embodiment so as to enable sufficient following of pressure fluctuations transmitted from the pressure-receiving chamber 70 to the intermediate chamber 92 at times of input of idling fundamental vibration, so that these pressure fluctuations of the intermediate chamber 92 may be transmitted to and escape into the equilibrium chamber 72.

With an engine mount tuned in the above manner, like that discussed previously, vibration damping action against low-frequency, large-amplitude vibration such as engine shake which is a problem during driving will be realized on the basis of the resonance action of fluid flowing through the main orifice passage 74. During this time, some of the pressure fluctuations arising in the pressure-receiving chamber 70 will escape to the intermediate chamber 92 via the input-end moveable plate 76, but fluid flow through the sub-orifice passage 96 will be produced nevertheless by pressure fluctuations arising in the intermediate chamber 92. In this instance, because the sub-orifice passage 96 has been tuned to a low-frequency range corresponding approximately to engine shake, vibration damping action against engine shake will be realized through concomitant resonance action of fluid flowing through this sub-orifice passage 96.

At times of input of low-frequency, medium-amplitude vibration such as rough idling vibration which is a problem with the car at a stop, there is a possibility that most of the pressure fluctuations arising in the pressure-receiving chamber 70 will escape to the intermediate chamber 92 via the input-end moveable plate 76; however, the output-end moveable plate 84 has high displacement rigidity so pressure fluctuations arising in the intermediate chamber 92 will be prevented from escaping to the equilibrium chamber 72. For this reason, a sufficient level of fluid flow through the sub-orifice passage 96 will be assured on the basis of pressure fluctuations arising in the intermediate chamber 92, and excellent vibration damping action (high-damping effect) against rough idling vibration will be realized on the basis of flow action of this fluid.

Further, pressure fluctuations arising in the pressure-receiving chamber 70 in relation to idling fundamental vibration which is a problem with the car at a stop will escape from the intermediate chamber 92 to the equilibrium chamber 72 through the agency of the input-end and output-end moveable plates 76, 84. For this reason, development of extremely high dynamic spring resulting from the main and sub-orifice passages 74, 96 becoming substantially blocked off can be avoided, and excellent vibration-damping can be realized on the basis of low dynamic spring action.

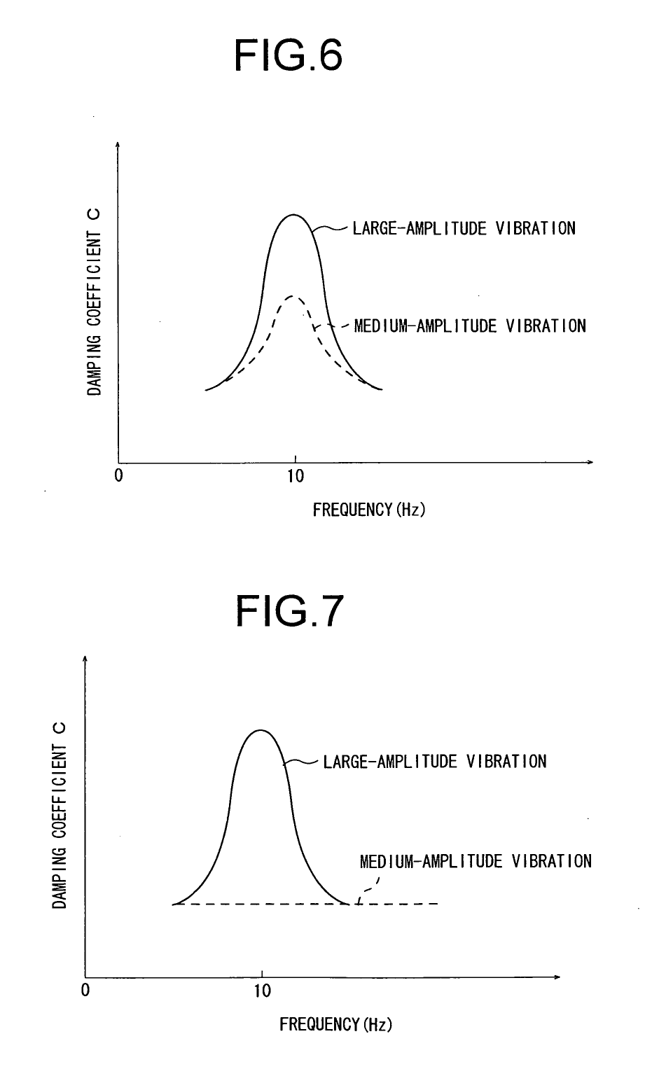

In the engine mount 10 of the present embodiment tuned in this way, where the frequency characteristics of the damping coefficient: C in the low-frequency range are evaluated in the case of input of low-frequency, large-amplitude vibration corresponding to engine shake (amplitude of ±0.5 mm) and in the case of input of low-frequency, medium-amplitude vibration corresponding to rough idling vibration (amplitude of ±0.3 mm), the results are as depicted in FIG. 6. Where the frequency characteristics of the damping coefficient: C in the low-frequency range are evaluated in a fluid-filled engine mount equipped with a conventional liquid pressure absorption mechanism (e.g. an engine mount like that disclosed in JP 64-49731 A) lacking an intermediate chamber (92), an input-end moveable plate (76), and a sub-orifice passage 96 but instead provided simply with a output-end moveable plate 84 situated between the pressure-receiving chamber 70 and the equilibrium chamber 72 are evaluated in the case of input of low-frequency, large-amplitude vibration corresponding to engine shake (amplitude of ±0.5 mm) and in the case of input of low-frequency, medium-amplitude vibration corresponding to rough idling vibration (amplitude of ±0.3 mm), the results are as depicted in FIG. 7. The reason that the fluid-filled engine mount equipped with the conventional liquid pressure absorption mechanism gives such results is that even in the case of input of rough idling vibration, pressure fluctuations arising in the pressure-receiving chamber 70 are absorbed by the liquid pressure absorption mechanism which relies on the moveable rubber plate. From the graphs of characteristics shown in FIGS. 6 and 7 it will be appreciated that the engine mount 10 of the present embodiment is especially effective against rough idling vibration.

While one embodiment of the present invention has been shown in detail hereinabove, this is merely exemplary, and the present invention should not be construed in any way as limited to the specific description of the embodiment.

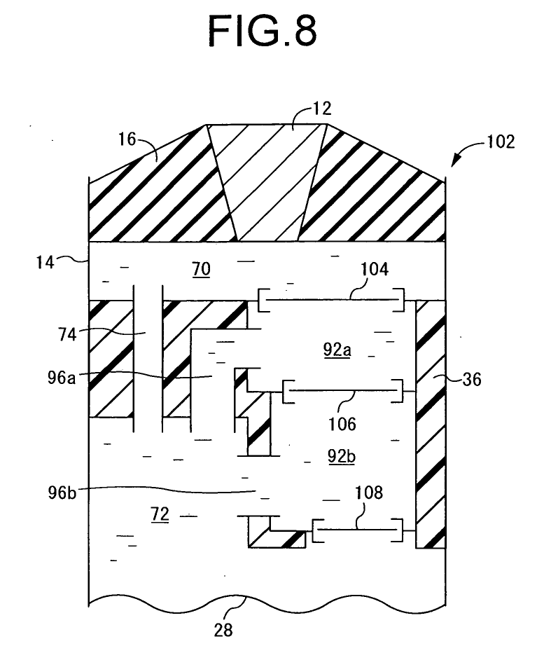

For example, whereas the construction of the preceding embodiment is provided with a single intermediate chamber 92, it would be possible to provide a series of two intermediate chambers 92a, 92b between the pressure-receiving chamber 70 and the equilibrium chamber 72, as depicted in model form in FIG. 8. For ease of understanding, components and parts that are comparable in construction to the preceding embodiment are assigned the same symbols in the drawing as in the preceding embodiment, and are not described in any detail.

In the engine mount 102 of this construction, the pressure-receiving chamber 70-end wall of the first intermediate chamber 92a which is situated towards the pressure-receiving chamber 70 end is constituted by a first moveable rubber plate 104 serving as the input-end moveable plate, while the equilibrium chamber 72-end wall of the first intermediate chamber 92a is constituted by a second moveable rubber plate 106 serving as the output-end moveable plate. The pressure-receiving chamber 70-end wall of the other intermediate chamber 92b which is situated towards the equilibrium chamber 72 end is constituted by the second moveable rubber plate 106 serving as the input-end moveable plate, while the equilibrium chamber 72-end wall of the other intermediate chamber 92b is constituted by a third moveable rubber plate 108 serving as the output-end moveable plate.

That is, in the engine mount 102 depicted in FIG. 8, the output-end moveable plate of the first intermediate chamber 92a situated towards the pressure-receiving chamber 70 end also functions as the input-end moveable plate of the other intermediate chamber 92b situated towards the equilibrium chamber 72 end.

In the engine mount 102 depicted in FIG. 8, the effective planar area of the second moveable rubber plate 106 is set smaller than the effective planar area of the first moveable rubber plate 104 so that the amount of capacity variability allowed in association with displacement of the second moveable rubber plate 106 will be smaller than the amount of capacity variability allowed in association with displacement of the first moveable rubber plate 104. Further, the effective planar area of the third moveable rubber plate 108 is set even smaller than the effective planar area of the second moveable rubber plate 106 so that the amount of capacity variability allowed in association with displacement of the third moveable rubber plate 108 will be smaller than the amount of capacity variability allowed in association with displacement of the second moveable rubber plate 106.

In the engine mount 102 of FIG. 8, the respective amounts of displacement allowed in the plate thickness direction for the first, second, and third moveable rubber plates 104, 106, 108 are set to approximately identical values. However, amounts of allowable displacement could be different from one another; the amount of allowable displacement of the second moveable rubber plate 106 could be smaller than that of the first moveable rubber plate 104, and the amount of allowable displacement of the third moveable rubber plate 108 could be smaller still. Where amounts of allowable displacement differ relative to each other in this way, it will be possible for the first, second, and third moveable rubber plates 104, 106, 108 to have approximately identical effective planar area.

Further, in the engine mount 102 depicted in FIG. 8, the resonance frequency (tuning frequency) of fluid caused to flow through the main orifice passage 74 which interconnects the pressure-receiving chamber 70 with the equilibrium chamber 72 will be tuned to a low-frequency range of around 10 Hz corresponding to engine shake vibration; the resonance frequency (tuning frequency) of fluid caused to flow through the first-sub-orifice passage 96a provided as a sub-orifice passage which interconnects one intermediate chamber 92a with the equilibrium chamber 72 will be tuned to a low-frequency range of around 10 Hz corresponding to rough idling vibration; and the resonance frequency (tuning frequency) of fluid caused to flow through the second-sub-orifice passage 96b provided as a sub-orifice passage which interconnects the other intermediate chamber 92b with the equilibrium chamber 72 will be tuned to a low-frequency range of around 20 Hz corresponding to normal idling fundamental vibration, for example.

The tuning frequencies of these main, first-sub, and second-sub orifice passages 74, 96a, 96b are not limited to those of modes set forth above, and it would be acceptable for example to tune the main orifice passage 74 to the low-frequency range of engine shake, to tune the first-sub-orifice passage 96a to the medium-frequency range of normal idling vibration, and to tune the second-sub-orifice passage 96b to a high-frequency range of driving rumble or the like.

In this engine mount 102 as well, because displacement levels of the first to third moveable rubber plates 104, 106, 108 have been set appropriately, as in the preceding embodiments, vibration damping effect based on resonance action of fluid through the orifice passages 74, 96a, 96b can be effectively realized against each of several types of vibration of different amplitude.

Also, the plurality of supporting projections 80 provided to the input-end moveable plate 76 and the plurality of supporting projections 88 provided to the output-end moveable plate 84 in the preceding embodiment are not essential elements, and it would be acceptable for example for the outside peripheral edge part of the input-end moveable plate 76 to be held clasped about its entire circumference, and for the outside peripheral edge part of the output-end moveable plate 84 to be held clasped about its entire circumference. Further, in the preceding embodiments, the outside peripheral edge part of the input-end moveable plate 76 need not be constrained, and the input-end moveable plate 76 could instead be constituted so as to undergo displacement in its entirety; likewise, the outside peripheral edge part of the output-end moveable plate 84 need not be constrained, and the output-end moveable plate 84 could instead be constituted so as to undergo displacement in its entirety.

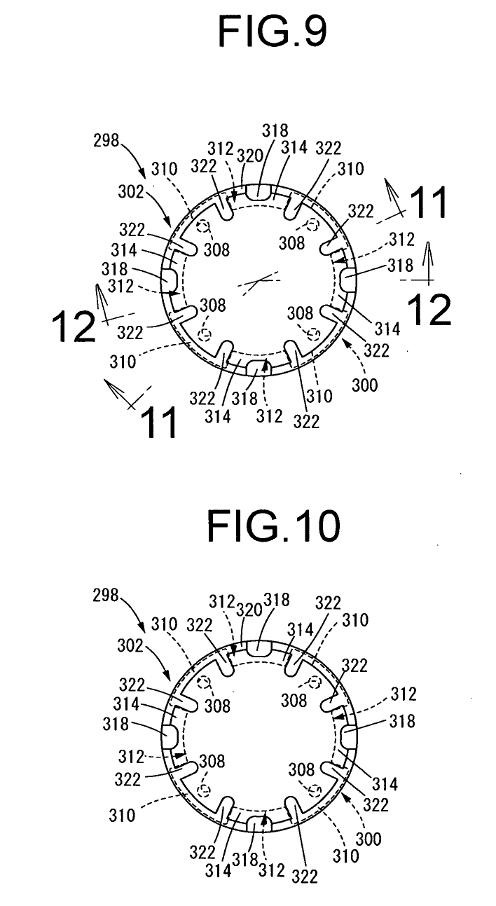

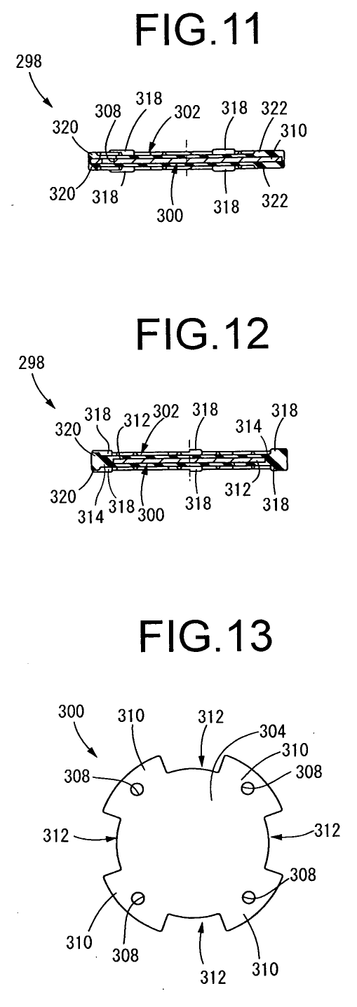

Furthermore, at least one of the input-end moveable plate 76 and the output-end moveable plate 84 of the engine mount 10 shown in FIG. 1 may be composed of a moveable plate member 298 having the specific structure as described hereinafter with reference to FIGS. 9-13. As depicted in FIGS. 9 to 12, the moveable plate member 298 has generally circular disk shape overall, and has integral construction of a constraining plate 300 sheathed with film-like rubber 302. In the following description, the moveable plate member 298 is used as the output-end moveable plate 84.

The constraining plate 300 is made of rigid material such as metal or synthetic resin, and takes the form of a thin flat plate. In the present embodiment in particular, as depicted in FIG. 13 the constraining plate 300 will have a plurality (in the present embodiment there are four) of plate segment large-diameter portions 310 with arcuate plate contours that are integrally formed with and project diametrically outward from the outside peripheral edge part of a constraining plate body 304 of circular disk shape. The plate segment large-diameter portions 310 are formed at approximately equal intervals, in other words, the outside peripheral edge part of a single disk has a shape produced by cutting away arcuate shapes at four equidistant locations in the circumferential direction. Put yet another way, the constraining plate 300 has an irregular shape provided on its circumference with small-diameter portions 312 where plate segment large-diameter portions 310 are absent, and large-diameter portions constituting the plate segment large-diameter portions 310, disposed in alternating fashion in the circumferential direction.

The outside diameter dimension of the small-diameter portions 312 will be the same as or slightly smaller than the inside diameter dimensions of the inside diameter dimension of the shoulder face 56 and the inside diameter dimension of the center hole 68. Meanwhile, the outside diameter dimension of the plate segment large-diameter portions 310 will be larger than the inside diameter dimensions of the shoulder face 56 and the inside diameter dimension of the center hole 68.

The film-like rubber 302 is vulcanization bonded over the whole face of the constraining plate 300 so as to cover it in its entirety. A plurality of through-holes 308 are formed at appropriate locations in the constraining plate 300, and the portions of the film-like rubber 302 that cover both the front and back sides are unified with one another by rubber filling these through-holes 308.

By sheathing the constraining plate 300 with the film-like rubber 302, the moveable plate member 298 is given circular disk shape of constant outside diameter dimension along the entire circumference with this outside diameter dimension thereof being slightly smaller than the inside diameter dimension of the lower large-diameter portion 62 in the partition member 36. The film-like rubber 302 not only covers the surfaces of the constraining plate 300 but also extends out to fill areas situated between adjacent large-diameter portions 310, 310 in the circumferential direction to the outside peripheral side of the small-diameter portions 312, so as to define in these areas elastic film portions 314 that are composed of rubber alone and have the same flat plate shape as in the constraining plate 300-embedded zone. That is, due to the absence of the embedded constraining plate 300, the elastic film portions 314 readily allow elastic deformation. These elastic film portions 314 are formed to the outside peripheral side of all of the small-diameter portions 312; and both the front and back faces of the elastic film portions 314 are coplanar with the surfaces of the film-like rubber 302 sheathing the front and back of the constraining plate 300 in the constraining plate 300-embedded zone. As a result, the moveable plate member 298 will have circular disk shape of constant outside diameter dimension overall in areas of both the small-diameter portions 312 and the plate segment large-diameter portions 310.

Elastic contacting projections 318, 318 are integrally formed on the elastic film portions 314 so as to project out respectively from the front and back faces of the center section. In the present embodiment, the elastic contacting projections 318 are block shaped having planar contours of generally arcuate or generally rectangular shape, with their outside peripheral edge part on the basal end side established at a location away from the outside peripheral edge part of the constraining plate 300. Through this arrangement, a zone unconstrained by the constraining plate 300 and allowing elastic deformation of the elastic film portions 314 will be provided at the perimeter of the elastic contacting projections 318. The projecting distal end faces of the elastic contacting projections 318 are constituted as generally flat contact faces.

Further, restraining elastic ribs 320, 320 that extend in the circumferential direction on the front and back faces respectively are integrally formed with the film-like rubber 302 at the outside peripheral edge part of the moveable plate member 298. The restraining elastic ribs 320 are defined with arcuate belt shape so as to extend continuously in the circumferential direction between the plurality of elastic contacting projections 318 that project out from the outside peripheral edge part of the moveable plate member 298. The restraining elastic ribs 320 in the width direction (diametrical direction of the moveable plate member 298) are at least partly (in the present embodiment, substantially entirely) located over the outside peripheral edge part of the plate segment large-diameter portions 310. That is, in the sections defining the plate segment large-diameter portions 310, the restraining elastic ribs 320 are formed so as to extend in the circumferential direction through the outside peripheral edge part of the plate segment large-diameter portions 310.

The restraining elastic ribs 320 are defined by an unchanging cross sectional shape, preferably one with a tapering cross section such as a semicircular or trapezoidal shape. The projecting height of the restraining elastic ribs 320 is shorter than the projecting height of the elastic contacting projections 318.

In the outside peripheral section of the moveable plate member 298, a plurality of inward-extending ribs 322 that extend for prescribed length in the diametrical direction are formed spaced apart from one another by a prescribed distance in the circumferential direction. These inward-extending ribs 322 are formed so as to extend with unchanging cross section diametrically inward from the restraining elastic rib 320. Each of the inward-extending ribs 322 is formed over a plate segment large-diameter portion 310 in the constraining plate 300; in the present embodiment in particular, they are formed along both circumferential side edges of each plate segment large-diameter portion 310, and extend diametrically inward up to a diametrical location approximately identical to the diametrical basal end part of the plate segment large-diameter portions 310.

In preferred practice, like the restraining elastic ribs 320, the inward-extending ribs 322 will have tapering cross section. The projecting height of the inward-extending ribs 322 is the same as the projecting height of the restraining elastic ribs 320.

The distance between the two projecting faces of the elastic contacting projections 318, 118 on the front and back of the moveable plate member 298 and which represents the maximum thickness dimension will be the same as or larger than the distance between the opposing faces of the two side walls (i.e., shoulder face 56 and the lower partition plate 42) of the lower large-diameter portion 62 of the partition member 36. Thus, with the moveable plate member 298 assembled with the partition member 36, the projecting distal end faces of the elastic contacting projections 318, 318 on the front and back of the moveable plate member 298 will be positioned in contact against the opposing inside faces of the lower large-diameter portion 62.

Meanwhile, the restraining elastic ribs 320 and the inward-extending ribs 322 provided on the front and back of the moveable plate member 298 will be positioned with their projecting distal end faces facing the opposing inside faces of the two side walls of the lower large-diameter portion 62, but in a noncontact condition across a small gap.

Here, with the exception of the areas around the sections defining the elastic contacting projections 318, the moveable plate member 298 is reinforced substantially in its entirety by the constraining plate 300, thereby substantially inhibiting deformation, and therefore displacement in the plate thickness direction based on a pressure differential between the front and back sides as discussed above will be produced in the moveable plate member 298 in its entirety.

With progressively larger amounts of displacement of the moveable plate member 298 in the plate thickness direction, following initial contact of the elastic contacting projections 318 the restraining elastic ribs 320 and the inward-extending ribs 322 will in turn also come into contact against the opposing inside faces of the two side walls of the lower large-diameter portion 62 of the partition member 36. Thus, elastic resistance force against displacement of the moveable plate member 298 will reach a high level, and displacement of the moveable plate member 298 will be limited due to spring characteristics that have increased in a nonlinear manner.

Here, because the restraining elastic ribs 320 and the inward-extending ribs 322 come into contact against the partition member 36 only after the elastic contacting projections 318 have first come into contact against the partition member 36 and on the basis of their deformation have elastically limited deformation of the moveable plate member 298, limitation of displacement of the moveable plate member 298 takes place in nonlinear fashion with two-stage spring characteristics. For this reason, impingement and noise when the restraining elastic ribs 320 and the inward-extending ribs 322 come into contact against the partition member 36 may be effectively reduced.

Moreover, at the time of initial contact of the elastic contacting projections 318, extremely soft spring characteristics will be realized due to shear deformation occurring in the thin elastic film portions 314 that are composed of rubber alone; while the restraining elastic ribs 320 and the inward-extending ribs 322 that subsequently come into contact with the partition member 36 are formed over the surface of the constraining plate 300, and as such will exhibit hard spring characteristics due to compressive deformation. For this reason, nonlinear spring characteristics may be efficiently realized during contact of the elastic contacting projections 318, the restraining elastic ribs 320, and the inward-extending ribs 322 against the partition member 36.

Additionally, because the restraining elastic ribs 320 and the inward-extending ribs 322 are formed along the peripheral edge part of the plate segment large-diameter portions 310 that are situated diametrically outermost in the constraining plate 300, when the restraining elastic ribs 320 and the inward-extending ribs 322 come into contact against the partition member 36, displacement-limiting effect may be brought to bear on efficiently and consistently on the constraining plate 300 as a whole, and the desired amount of displacement of the moveable plate member 298 may be achieved more effectively.

After the elastic contacting projections 318, the restraining elastic ribs 320, and the inward-extending ribs 322 have come into contact against the partition member 36 in the manner described above, in the event that the amount of displacement of the moveable plate member 298 has increased further, substantially the entire outside peripheral section of the moveable plate member 298 will now be positioned in contact against the opposing inside faces of the upper and lower side walls of the lower large-diameter portion 62. Since the plate segment large-diameter portions 310 of the constraining plate 300 are arranged in this contacting section, reliable displacement-limiting effect on the moveable plate member 298 will be realized.

During limitation of the amount of displacement of the moveable plate member 298 in this way, cushioning action afforded by the elastic contacting projections 318, the restraining elastic ribs 320, and the inward-extending ribs 322 in the manner described previously will effectively prevent noise and impingement from arising in association with the moveable plate member 298 coming into contact against the partition member 36. Moreover, as mentioned earlier, the reinforcing effect afforded by the constraining plate 300 will prevent pressure of the intermediate chamber 92 from escaping any more than necessary due to factors such as deformation of the moveable plate member 298, thereby ensuring a reliable and consistent level of fluid flow through the sub-orifice passage 96 so that the desired vibration damping effect by the sub-orifice passage 96 may be more effectively realized.

Additionally, whereas the preceding embodiments described implementation of the present invention in an automotive engine mount by way of specific example, it would be possible for the present invention to be implemented in an automotive body mount, diff mount, suspension mount or the like; or in vibration-damping devices of various vibrating bodies besides automobiles.

Also, whereas in the preceding embodiments, reinforcing fittings 82, 90 are anchored in the input-end and output-end moveable plates 76, 84, such reinforcing fittings are not essential. In the preceding embodiments in particular, reinforcing fittings 82, 90 of annular plate shape having a through-hole formed in the center section were employed, with the through-hole of the center section being blocked off by a rubber elastic film; however, it would be acceptable to employ reinforcing fittings that lack such a through-hole formed in the center section. However, an advantage of the input-end and output-end moveable plates 76, 84 constructed with a through-hole in the center section blocked off by a rubber elastic film is that it will be possible to avoid development of extremely high dynamic spring at times of input of high-frequency vibration higher than the tuning frequency of the main orifice passage and the sub-orifice passage, since pressure fluctuations arising in the pressure-receiving chamber and the intermediate chamber at such times will be absorbed through elastic deformation of the rubber elastic film which blocks off the through-hole in the center section.

It is also to be understood that the present invention may be embodied with various other changes, modifications and improvements, which may occur to those skilled in the art, without departing from the spirit and scope of the invention defined in the following claims.

What is claimed is:

1. A fluid-filled type vibration-damping device comprising:
a pressure-receiving chamber whose wall is defined in part by a main rubber elastic body, and that gives rise to pressure fluctuations at times of vibration input and is filled with a non-compressible fluid;
a variable-capacity equilibrium chamber whose wall is defined in part by a flexible film, and that is filled with a non-compressible fluid and has a flexible volume;
a main orifice passage interconnecting the pressure-receiving chamber and the equilibrium chamber;
at least one intermediate chamber formed separately from the pressure-receiving chamber and the equilibrium chamber and filled with a non-compressible fluid;
an input-end moveable plate having restricted deformation, situated on a wall of the intermediate chamber and adapted to undergo displacement in response to pressure from the pressure-receiving chamber directed onto a face on an opposite side from the intermediate chamber so as to transmit pressure from the pressure-receiving chamber to the intermediate chamber and give rise to pressure fluctuations in the intermediate chamber;
an output-end moveable plate situated on a different wall from the input-end moveable plate in the intermediate chamber and adapted to transmit pressure fluctuations of the intermediate chamber to the equilibrium chamber to dispel pressure fluctuations of the intermediate chamber, and having restricted deformation such that an amount of capacity variability permitted in association with displacement is smaller than that of the input-end moveable plate; and
a sub-orifice passage interconnecting the intermediate chamber and the equilibrium chamber.

2. The fluid-filled type vibration-damping device according to claim 1, wherein an effective planar area of the output-end moveable plate is smaller than an effective planar area of the input-end moveable plate.

3. The fluid-filled type vibration-damping device according to claim 1, wherein the main orifice passage and the sub-orifice passage may be tuned to a same frequency range.

4. The fluid-filled type vibration-damping device according to claim 1, wherein the at least one intermediate chamber comprises a single intermediate chamber, and the input-end moveable plate is disposed between the pressure-receiving chamber and the intermediate chamber so that pressure of the pressure-receiving chamber is exerted on one face of the input-end moveable plate while pressure of the intermediate chamber is exerted on another face, while giving rise to displacement of the input-end moveable plate on a basis of pressure differential between the pressure-receiving chamber and the equilibrium chamber, whereby pressure fluctuations of the pressure-receiving chamber is transmitted to the intermediate chamber; and
wherein the output-end moveable plate is disposed between the intermediate chamber and the equilibrium chamber so that pressure fluctuations arising in the intermediate chamber will escape to the equilibrium chamber through displacement of the output-end moveable plate on the basis of pressure differential between the intermediate chamber and the equilibrium chamber.

5. The fluid-filled type vibration-damping device according to claim 1, wherein the at least one intermediate chamber comprises a plurality of intermediate chambers, and the plurality of intermediate chambers are disposed serially between the pressure-receiving chamber and the equilibrium chamber; and, of any two mutually serially arranged intermediate chambers, the output-end moveable plate provided to a first intermediate chamber that is situated towards the pressure-receiving chamber end functions also as the input-end moveable plate of another intermediate chamber that is situated towards the equilibrium chamber end.

6. The fluid-filled type vibration-damping device according to claim 1, wherein at least one of the input-end moveable plate and the output-end moveable plate is composed of a moveable plate member comprising a rigid constraining plate sheathed with film-like rubber, the constraining plate having irregular shape of varying outside diameter dimension in a circumferential direction and provided with alternating small-diameter portions and large-diameter portions in the circumferential direction;
sections defining the small-diameter portions of the constraining plate constitute elastic film portions composed of single-layer structure of film-like rubber; a plurality of elastic contacting projections that project out to either side in a plate thickness direction are integrally formed in the elastic film portions that have been provided at multiple locations along a circumference of an outside peripheral section of the moveable plate member, the plurality of elastic contacting projections being adapted to come into initial contact with a partition member which parts the pressure-receiving chamber and the equilibrium chamber from each other during displacement of the moveable plate member in the plate thickness direction;
restraining elastic ribs that connect in the circumferential direction with the plurality of elastic contacting projections and that extend in the circumferential direction through the outside peripheral section of the moveable plate member are integrally formed with the elastic film portions in the large-diameter portions of the constraining plate, with the restraining elastic ribs being adapted to come into contact against the partition member after the elastic contacting projections do during displacement of the moveable plate member in the plate thickness direction; and
inward-extending ribs that extend diametrically inward on the large-diameter portions of the constraining plate are formed at multiple locations along a circumference of the restraining elastic ribs, with the inward-extending ribs adapted to also come into contact against the partition member during displacement of the moveable plate member in the plate thickness direction.

7. The fluid-filled type vibration-damping device according to claim 6, wherein on the large-diameter sections of the constraining plate, the restraining elastic ribs are formed so as to extend in the circumferential direction along an outside peripheral edge part of the large-diameter section, while the inward-extending ribs are formed so as to extend in a diametrical direction along both circumferential side edge parts of the large-diameter section.

8. The fluid-filled type vibration-damping device according to claim 6, wherein both the restraining elastic ribs and the inward-extending ribs project out to both sides in the plate thickness direction from the constraining plate, with smaller height dimension as compared to the elastic contacting projections.

9. A fluid-filled type vibration-damping device comprising:
a first mounting member;
a second mounting member;
a main rubber elastic body elastically connecting the first and second mounting member;
a partition member that is supported by the second mounting member;
a pressure-receiving chamber defined to one side of the partition member, whose wall is defined in part by the main rubber elastic body, giving rise to pressure fluctuations at times of vibration input;
an equilibrium chamber defined to another side of the partition member and whose wall is defined in part by a flexible film;
a non-compressible fluid filling the pressure-receiving chamber and the equilibrium chamber;
a main orifice passage interconnecting the pressure-receiving chamber and the equilibrium chamber;
at least one intermediate chamber formed in the partition member to be separately from the pressure-receiving chamber and the equilibrium chamber and filled with a non-compressible fluid;
an input-end moveable plate having restricted deformation, situated at a section of the intermediate chamber opening towards the pressure-receiving chamber, and adapted to undergo displacement in response to pressure from the pressure-receiving chamber directed onto a face on an opposite side from the intermediate chamber so as to transmit pressure from the pressure-receiving chamber to the intermediate chamber and give rise to pressure fluctuations in the intermediate chamber;
an output-end moveable plate situated at a different section of the intermediate chamber opening toward the equilibrium chamber, and adapted to transmit pressure fluctuations of the intermediate chamber to the equilibrium chamber to dispel pressure fluctuations of the intermediate chamber, and having restricted deformation such that an amount of capacity variability permitted in association with displacement is smaller than that of the input-end moveable plate; and
a sub-orifice passage interconnecting the intermediate chamber and the equilibrium chamber,
wherein at least one of the input-end moveable plate and the output-end moveable plate is composed of a moveable plate member comprising a rigid constraining plate sheathed with film-like rubber, the constraining plate having irregular shape of varying outside diameter dimension in a circumferential direction and provided with alternating small-diameter portions and large-diameter portions in the circumferential direction;
sections defining the small-diameter portions of the constraining plate constitute elastic film portions composed of single-layer structure of film-like rubber; a plurality of elastic contacting projections that project out to either side in a plate thickness direction are integrally formed in the elastic film portions that have been provided at multiple locations along a circumference of an outside peripheral section of the moveable plate member, the plurality of elastic contacting projections being adapted to come into initial contact with the partition member during displacement of the moveable plate member in the plate thickness direction;
restraining elastic ribs that connect in the circumferential direction with the plurality of elastic contacting projections and that extend in the circumferential direction through the outside peripheral section of the moveable plate member are integrally formed with the elastic film portions in the large-diameter portions of the constraining plate, with the restraining elastic ribs being adapted to come into contact against the partition member after the elastic contacting projections do during displacement of the moveable plate member in the plate thickness direction; and
inward-extending ribs that extend diametrically inward on the large-diameter portions of the constraining plate are formed at multiple locations along a circumference of the restraining elastic ribs, with the inward-extending ribs adapted to also come into contact against the partition member during displacement of the moveable plate member in the plate thickness direction.
